(19) United States
(12) Patent Application Publication
(10) Pub. No.: US 2014/0320458 A1
(43) Pub. Date: Oct. 30, 2014

(54) TOUCH-SENSITIVE DISPLAY DEVICE

(71) Applicant: TIANJIN FUNAYUANCHUANG TECHNOLOGY CO.,LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 14/141,744

(22) Filed: Dec. 27, 2013

(30) Foreign Application Priority Data
Apr. 30, 2013 (CN) 2013101552071

(51) Int. Cl. G06F 3/042

(52) U.S. Cl. CPC G06F 3/042
USPC 345/175

(57) ABSTRACT

A touch-sensitive display device includes a protective module, a reflective display module, and a light guide touch module located between the protective module and the reflective display module. The light guide touch module includes a light guide module and a touch module attached on the light guide module. The light guide module includes a light guide plate. The touch module includes at least one carbon nanotube layer. The at least one carbon nanotube layer is directly located on a surface of the light guide plate.

### RELATED APPLICATIONS

This application claims all benefits accruing under 35 U.S.C. §119 from China Patent Application No. 201310155207.1, filed on Apr. 30, 2013 in the China Intellectual Property Office, the disclosure of which is incorporated herein by reference.

### BACKGROUND

1. Technical Field

The present application relates to a touch-sensitive display device, particularly, to a reflective display module based touch-sensitive display device.

2. Discussion of Related Art

A conventional reflective display module based touch-sensitive display device includes a protective layer, a touch element, a light guide plate, and a reflective display module. The reflective display module is a passive display element, can be, e.g., an e-paper (i.e., a microencapsulated electrophoretic display), or a reflective liquid crystal display. The touch element is an indium tin oxide (ITO) glass. The protective layer, the touch element, and the light guide plate are tacked with each other and fixed on the reflective display module by adhesives. When a light passes through the touch element and the light guide plate and arrives at the reflective display module, the light is reflected by the reflective display module to the eyes of a person.

How to reduce a thickness of the touch-sensitive display device is key in application of touch-sensitive display device. There are high temperature (>350° C.) and chemical etching in process of making ITO. However, the light guide plate will be destroyed in a temperature greater than 350 degrees or chemical etching, because the light guide plate is made of poly(methyl methacrylate) (PMMA) or polycarbonate (PC). Thus, the ITO touch element is not integrated together with the light guide plate in the conventional touch-sensitive display device.

One glass solution (OGS) is developed to integrate the ITO touch element with the protective layer. The ITO touch element is directly formed on a protective glass (protective layer) in OGS, to integrate the ITO touch element with the protective glass to form a whole structure. However, OGS is hard to operate, so the touch-sensitive display device is hard to mass produce. Moreover, quality of the touch-sensitive display device made by OGS can be low.

What is needed, therefore, is to provide a touch-sensitive display device that can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a three-dimensional exploded schematic view of one embodiment of a touch-sensitive display device.

FIG. 2 is a cross-sectional schematic view of one embodiment of the touch-sensitive display device of FIG. 1.

FIG. 3 is a scanning electron microscope (SEM) image of a drawn carbon nanotube film.

FIG. 4 is a schematic view of one embodiment of a carbon nanotube layer.

FIG. 5 is a schematic view of one embodiment of a carbon nanotube wire structure.

FIG. 6 is another schematic view of one embodiment of the carbon nanotube wire structure.

FIG. 7 is an SEM image of a twisted carbon nanotube wire.

FIG. 8 is an SEM image of an untwisted carbon nanotube wire.

FIG. 9 is a schematic view of another embodiment of the touch-sensitive display device.

FIG. 10 is a schematic view of yet another embodiment of the touch-sensitive display device

FIG. 11 is a three-dimensional exploded schematic view of yet another embodiment of a light guide touch module.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

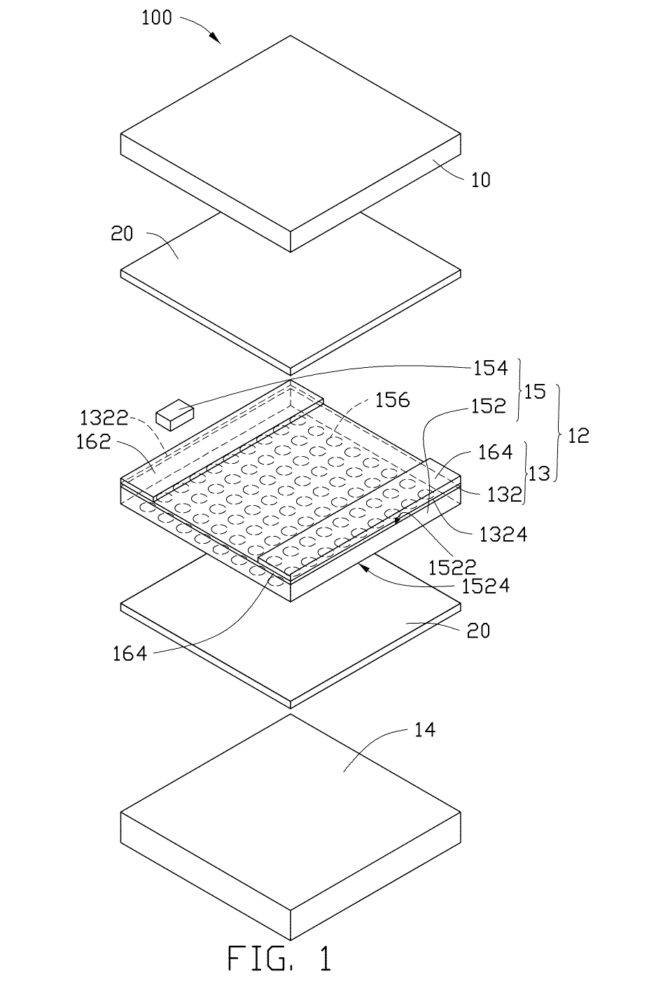

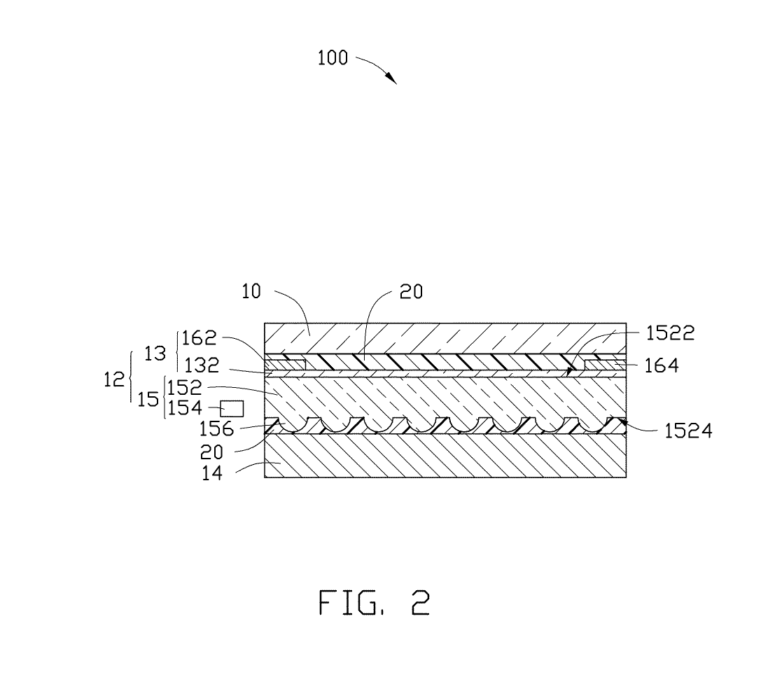

Referring to FIGS. 1 and 2, a touch-sensitive display device 100 of one embodiment includes a protective module 10, a light guide touch module 12, and a reflective display module 14. The light guide touch module 12 is sandwiched between the protective module 10 and the reflective display module 14 via two adhesive layers 20. The light guide touch module 12 is fixed on the reflective display module 14 by one adhesive layer 20. The light guide touch module 12 is fixed on the protective module 10 by another adhesive layer 20. The two adhesive layers 20 can be made of optical clear adhesive.

A material of the protective module 10 can be made of a flexible material or a rigid material, for example, glass or poly(ethylene terephthalate) (PET). A length, width and thickness of the protective module 10 can be selected according to need. In one embodiment, the protective module 10 is made of PET, the thickness of the protective module 10 is about 0.125 millimeters.

The reflective display module 14 is a passive display. The reflective display module 14 can work without back light source. The reflective display module 14 can be, e.g., an electronic paper display, an electronic ink display, an electronic skins display, or a reflective liquid crystal display (LCD). The reflective LCD can be a high aperture ratio thin film transistor LCD or a guest-host LCD. In one embodiment, the reflective display module 14 is the electronic ink display.

The light guide touch module 12 includes a light guide module 15 and a touch module 13. The light guide module 15 includes a light guide plate 152 and a light source 154 located beside a side of the light guide plate 152. The light source 154 can be a light emitting diode (LED) or a cold cathode fluorescent lamp (CCFL). The light source 154 can provide a beam of light. It is to be understood that the light source 154 can be selected according to need.

The light guide plate 152 has a first surface 1522 and a second surface 1524 opposite to the first surface 1522. A plurality of scattering dots 156 is defined in the light guide plate 152 at the first surface 1522 or the second surface 1524. The scattering dots 156 are evenly spaced from each other. When beams of light arrive at the scattering dots 156, directions of the beams of light will change because of reflection and diffusion, and the beams of light arrive at eyes of person. The scattering dots 156 can be, for example, hemispherical, V-shaped, or U-shaped. The scattering dots 156 can be formed as protrusions on or recessed in the light guide plate 152 at first surface 1522 or the second surface 1524. The scattering dots 156 may be different from each other in size and shape. In one embodiment, the scattering dots 156 are all hemispherical, substantially the same size, and formed as protrusions on the second surface 1524 of the light guide plate 152.

Method for making the scattering dots 156 on the light guide plate 152 can be selected according to need. The scattering dots 156 can be made in a mold by injection molding technology. Then the scattering dots 156 are transferred to the light guide plate 152 from the mold. It is to be understood that the scattering dots 156 can be made by chemical etching, laser direct writing, or precision machining.

The thickness and size of the light guide plate 152 are arbitrary and can be selected according to need. The light guide plate 152 may be made of plastic, polymethyl methacrylate (PMMA) or polycarbonate. In one embodiment, the light guide plate 152 is a square PMMA plate having a side length of about 40 millimeters, a thickness of about 0.4 millimeters, and a refractive index of about 1.49.

The touch module 13 can be located on the first surface 1522 or the second surface 1524 of the light guide plate 152. In one embodiment, the touch module 13 is located on the first surface 1522 of the light guide plate 152. The touch module 13 can be touched by single-point or multi-points. The touch module 13 can be inductance capacitance sensor.

The touch module 13 includes at least one carbon nanotube layer 132, at least one first electrode 162, and at least one second electrode 164. The at least one first electrode 162 and the at least one second electrode 164 are spaced from each other and electrically connected to the at least one carbon nanotube layer 132. The at least one carbon nanotube layer 132 is a transparent conductive layer.

The at least one carbon nanotube layer 132 can be located on the first surface 1522 or the second surface 1524 of the light guide plate 152. The at least one carbon nanotube layer 132 can be located between the protective module 10 and the light guide plate 152. The at least one carbon nanotube layer 132 can be located between the light guide plate 152 and reflective display module 14.

When the at least one carbon nanotube layer 132 is located between the protective module 10 and the light guide plate 152, that is, the at least one carbon nanotube layer 132 is located between the protective module 10 and light guide module 15, beams of light emitted from the light source 154 in the light guide module 15 arrive at the screen of the reflective display module 14 and reflected into the eyes of a person by the reflective display module 14, the beams of light pass through the at least one carbon nanotube layer 132 one time. Thus, loss of light is reduced, and light utilization is increased.

When the at least one carbon nanotube layer 132 is located between the light guide plate 152 and reflective display module 14, beams of light emitted from the light source 154 in the light guide module 15 arrive at the screen of the reflective display module 14 and reflected into the eyes of a person by the reflective display module 14, the beams of light pass through the at least one carbon nanotube layer 132 twice. Thus, loss of light is increased, and light utilization is reduced. In one embodiment, the at least one carbon nanotube layer 132 is located between the protective module 10 and the light guide plate 152.

In one embodiment, the plurality of scattering dots 156 is formed as protrusions on the second surface 1524 of the light guide plate 152, the at least one carbon nanotube layer 132 is located on the first surface 1522 of the light guide plate 152, as shown in FIG. 2.

The at least one carbon nanotube layer 132 includes a plurality of carbon nanotubes uniformly distributed therein. The plurality of carbon nanotubes can be combined by van der Waals attractive force. The at least one carbon nanotube layer 132 can be a substantially pure structure of the carbon nanotubes, with few impurities. The plurality of carbon nanotubes may be single-walled, double-walled, multi-walled carbon nanotubes, or their combinations. The carbon nanotubes which are single-walled have a diameter of about 0.5 nanometers (nm) to about 50 nm. The carbon nanotubes which are double-walled have a diameter of about 1.0 nm to about 50 nm. The carbon nanotubes which are multi-walled have a diameter of about 1.5 nm to about 50 nm.

The carbon nanotube layer 132 can be at least one drawn carbon nanotube film. The carbon nanotube layer can include a plurality of carbon nanotube wire structures.

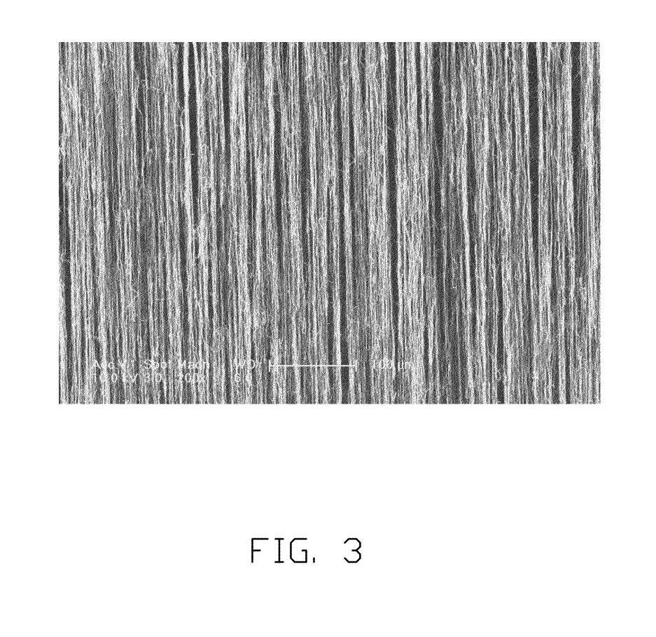

Referring to FIG. 3, the drawn carbon nanotube film includes a plurality of successive and oriented carbon nanotubes joined end-to-end by van der Waals attractive force therebetween. The carbon nanotubes in the drawn carbon nanotube film are oriented along a preferred orientation. The carbon nanotubes are parallel to a surface of the drawn carbon nanotube film. The drawn carbon nanotube film is a free-standing film. The drawn carbon nanotube film can bend to desired shapes without breaking. A film can be drawn from a carbon nanotube array to form the drawn carbon nanotube film.

The term “free-standing” includes, but not limited to, the drawn carbon nanotube film that does not have to be supported by a substrate. For example, the free-standing drawn carbon nanotube film can sustain the weight of itself when it is hoisted by a portion thereof without any significant damage to its structural integrity. So, if the free-standing drawn carbon nanotube film is placed between two separate supporters, a portion of the free-standing drawn carbon nanotube film, not in contact with the two supporters, would be suspended between the two supporters and yet maintain film structural integrity.

If the carbon nanotube layer includes at least two stacked drawn carbon nanotube films, adjacent drawn carbon nanotube films can be combined by only the van der Waals attractive force therebetween. Additionally, when the carbon nanotubes in the drawn carbon nanotube film are aligned along one preferred orientation, an angle can exist between the orientations of carbon nanotubes in adjacent drawn carbon nanotube films, whether stacked or adjacent. An angle between the aligned directions of the carbon nanotubes in two adjacent drawn carbon nanotube films can be in a range from about 0 degrees to about 90 degrees. Stacking the drawn carbon nanotube films will improve the mechanical strength of the at least one carbon nanotube layer 132, further improving the lifespan of the touch-sensitive display device 100. In one embodiment, the at least one carbon nanotube layer 132 is one drawn carbon nanotube film.

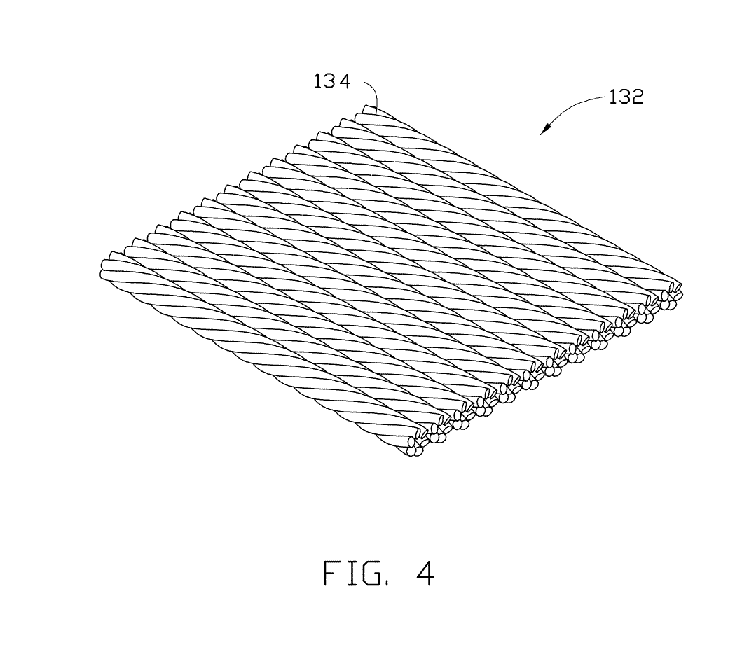

Referring to FIG. 4, the carbon nanotube layer includes a plurality of carbon nanotube wire structures 134 arranged in parallel. The plurality of carbon nanotube wire structures 134 is spaced from each other.

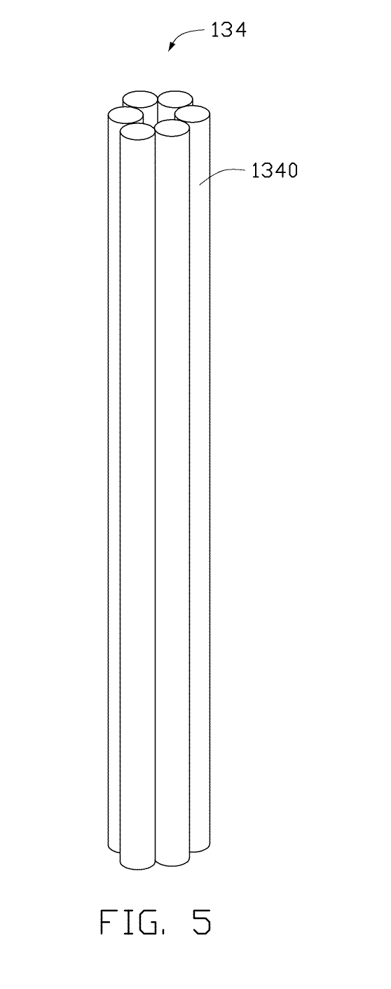

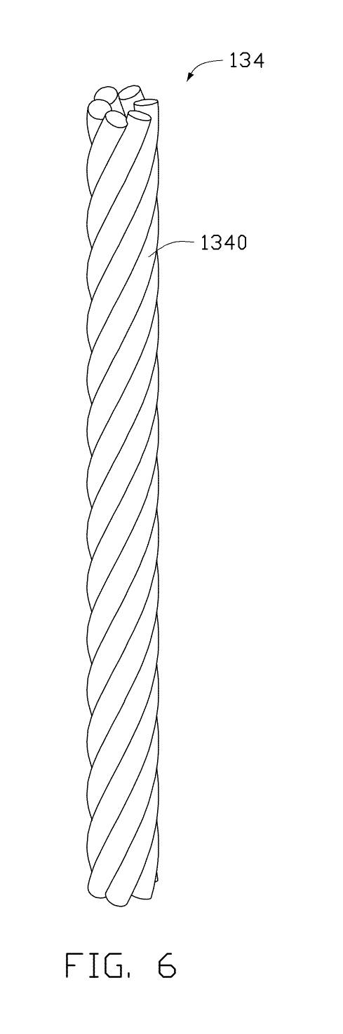

Referring to FIG. 5, each of the plurality of the carbon nanotube wire structure 134 includes a plurality of carbon nanotube wires 1340 substantially parallel with each other. Referring to FIG. 6, each of the plurality of the carbon nanotube wire structure 134 includes a plurality of carbon nanotube wires 1340 twisted with each other.

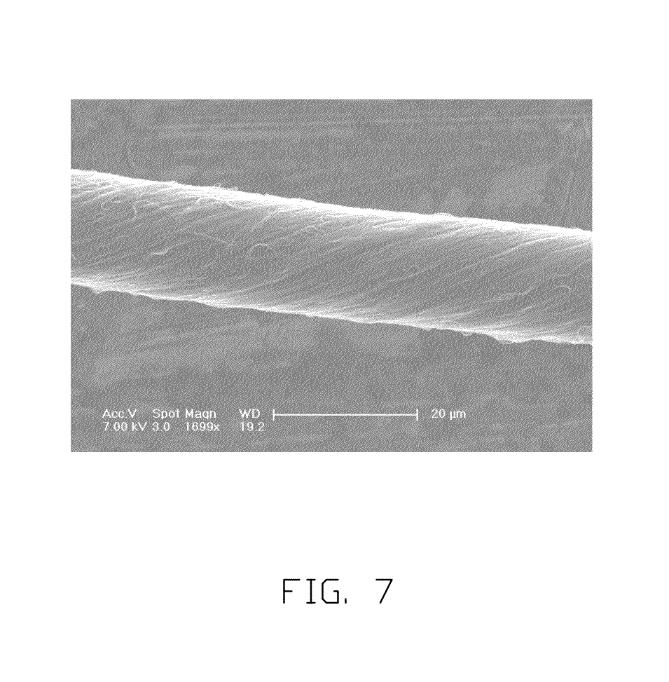

The carbon nanotube wire 1340 can be twisted or untwisted. The twisted carbon nanotube wire 1340 can be formed by twisting the drawn carbon nanotube film using a mechanical force to turn the two ends of the drawn carbon nanotube film in opposite directions. Referring to FIG. 7, the twisted carbon nanotube wire 1340 includes a plurality of carbon nanotubes helically oriented around an axial direction of the twisted carbon nanotube wire 1340. A length of the twisted carbon nanotube wire 1340 can be set as desired. In one embodiment, the length of the twisted carbon nanotube wire 1340 can be in a range from about 10 micrometers to about 100 micrometers. A diameter of the twisted carbon nanotube wire 1340 can be in a range from about 0.5 nanometers to about 100 micrometers. Further, the twisted carbon nanotube wire 1340 can be treated with a volatile organic solvent after being twisted. After being soaked by the organic solvent, the adjacent paralleled carbon nanotubes in the twisted carbon nanotube wire 1340 will bundle together. The specific surface area of the twisted carbon nanotube wire 1340 will decrease, while the density and strength of the twisted carbon nanotube wire 1340 will increase. The carbon nanotubes in the carbon nanotube wire 1340 can be single-walled, double-walled, or multi-walled carbon nanotubes.

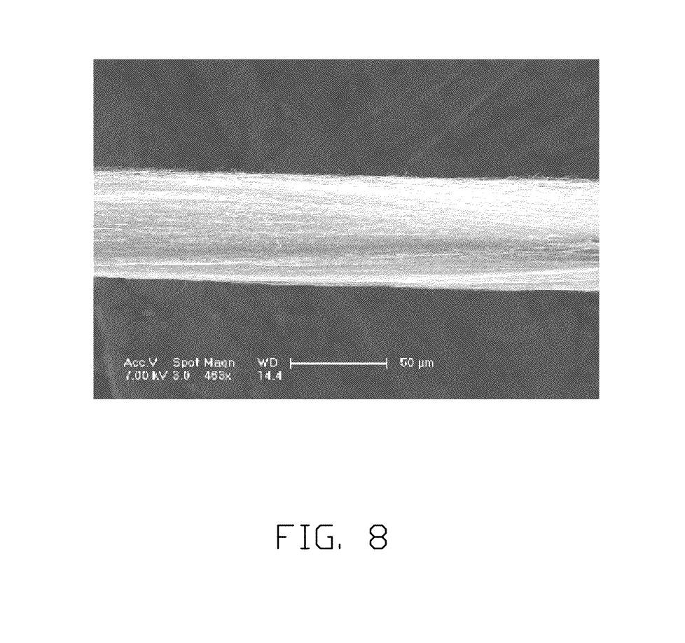

The untwisted carbon nanotube wire 1340 can be obtained by treating the drawn carbon nanotube film drawn from the carbon nanotube array with the volatile organic solvent. Specifically, the organic solvent is applied to soak the entire surface of the drawn carbon nanotube film. During the soaking, adjacent parallel carbon nanotubes in the drawn carbon nanotube film will bundle together, due to the surface tension of the organic solvent as it volatilizes, and thus, the drawn carbon nanotube film will be pulled together to form the untwisted carbon nanotube wire 1340. Referring to FIG. 8, the untwisted carbon nanotube wire 1340 includes a plurality of carbon nanotubes substantially oriented along a same direction (i.e., a direction along the length of the untwisted carbon nanotube wire 1340). The carbon nanotubes are substantially parallel to the axis of the untwisted carbon nanotube wire 1340. More specifically, the untwisted carbon nanotube wire 1340 includes a plurality of successive carbon nanotubes joined end to end by van der Waals attractive force therebetween. A length of the untwisted carbon nanotube wire 1340 can be arbitrarily set as desired. In one embodiment, the length of the untwisted carbon nanotube wire 1340 can be in a range from about 10 micrometers to about 100 micrometers. A diameter of the untwisted carbon nanotube wire 1340 can be in a range from about 0.5 nanometers to about 100 micrometers. In one embodiment, the diameter of the untwisted carbon nanotube wire 1340 is in a range from about 100 nanometers to about 100 micrometers.

The carbon nanotube layer is a substantially pure structure of the carbon nanotubes, with few impurities. The carbon nanotubes have low specific surface area, and are combined by van der Waals attractive force. Thus, the carbon nanotube layer has viscosity and can be located directly on the light guide plate 152 without an adhesive. It is to be understood that the carbon nanotube layer can be located on the light guide plate 152 by an adhesive.

The at least one first electrode 162 and the at least one second electrode 164 can be located on a surface of the at least one carbon nanotube layer 132. The at least one first electrode 162 and the at least one second electrode 164 are spaced from each other. The at least one carbon nanotube layer 132 has a first side 1322 and a second side 1324 opposite to the first side 1322. The carbon nanotubes in the at least one carbon nanotube layer 132 can be arranged primarily along a direction extending from the first side 1322 to the second side 1324.

In detail, setting ways for the at least one first electrode 162 and the at least one second electrode 164 and the at least one carbon nanotube layer 132 are as follows: (1) when the number of the at least one first electrode 162 is one and the at least one second electrode 164 includes a plurality of second electrodes 164, the one first electrode 162 is located on the first side 1322 and the plurality of second electrodes 164 is located on the second side 1324; (2) when the at least one first electrode 162 includes a plurality of first electrodes 162 and the at least one second electrode 164 includes a plurality of second electrodes 164, the plurality of first electrodes 162 is located on the first side 1322 and the plurality of second electrodes 164 is located on the second side 1324, each of the plurality of first electrodes 162 and each of the plurality of second electrodes 164 is one-to-one correspondence; (3) when the number of the at least one first electrode 162 is one and the number of the at least one second electrode 164 is one, the one first electrode 162 is located on the first side 1322 and the one second electrode 164 is located on the second side 1324. In one embodiment, the one first electrode 162 is located on the first side 1322 and the one second electrode 164 is located on the second side 1324, as shown in FIG. 1.

The location of the at least one first electrode 162 and the at least one second electrode 164 is related to the arranged direction of the carbon nanotubes in the at least one carbon nanotube layer 132. When the at least one carbon nanotube layer 132 is at least one drawn carbon nanotube film, a direction from the at least one first electrode 162 on the first side 1322 to the corresponded the at least one second electrode 164 on the second side 1324 is parallel to the extending direction of each carbon nanotube. When the at least one carbon nanotube layer 132 includes a plurality of carbon nanotube wire structures 134, a direction from the at least one first electrode 162 on the first side 1322 to the corresponded the at least one second electrode 164 on the second side 1324 is parallel to the extending direction of each carbon nanotube wire.

In one embodiment, the at least one carbon nanotube layer 132 is a drawn carbon nanotube film, the at least one first electrode 162 is one first electrode 162, and the at least one second electrode 164 is one second electrode 164. The first electrode 162 and the second electrode 164 are silver ribbons, and located on the surface of the drawn carbon nanotube film. The first electrode 162 and the second electrode 164 are separately located to avoid short-circuiting. The carbon nanotube in the drawn carbon nanotube film extends along a direction from the first electrode 162 to the second electrode 164.

The at least one first electrode 162 and the at least one second electrode 164 can be made by a method such as screen printing, chemical vapor deposition, or magnetron sputtering. Thicknesses of the at least one first electrode 162 and the at least one second electrode 164 are in a range from about 10 nm to about 500 microns. The at least one first electrode 162 and the at least one second electrode 164 are made of conductive materials. A structure of the at least one first electrode 162 and the at least one second electrode 164 is not limited and can be lamellar, wire, ribbon, block or other structure. A material of the at least one first electrode 162 and the at least one second electrode 164 can be chosen from a group that includes metal, alloy, indium tin oxide, antimony tin oxide, conductive silver glue, conductive polymer, conductive carbon nanotubes, and so on. A material of the metal or alloy includes aluminum, copper, tungsten, molybdenum, gold, titanium, neodymium, palladium, cesium, silver, or any combination thereof.

In the light guide touch module 12, the at least one carbon nanotube layer 132 is directly pasted to the light guide plate 152, so a substrate for sustaining the carbon nanotube layer can be omitted. Thus, thickness of the touch-sensitive display device 100 reduces. In process of making the carbon nanotube layer, there are no high temperature and chemical etching. Thus, when the carbon nanotube layer is directly pasted to the light guide plate 152 without high temperature and chemical etching, the light guide plate 152 remains undamaged, and the yield rate of the touch-sensitive display device 100 is increased. The yield rate can be in a range from about 80% to about 90%. Moreover, the touch-sensitive display device 100 is easy to operate and can be mass produced in a large quantity.

When the touch-sensitive display device 100 is operated in insufficient light or without light, the reflective display module 14 cannot emit beams of light, and the light source 154 can emit beams of light. The beams of light pass through the light guide plate 152 and arrive at the screen of the reflective display module 14. Then the beams of light are reflected and scattered into the eyes, wherein the at least one carbon nanotube layer 132 is between the protective module 10 and the light guide plate 152.

When the touch-sensitive display device 100 is operated in sufficient light, the reflective display module 14 cannot emit beams of light, and the light source 154 does not need to emit beams of light. The light passes through the at least one carbon nanotube layer 132 and the light guide plate 152 and arrives at the screen of the reflective display module 14. Then the light is reflected and scattered into the eyes, wherein the at least one carbon nanotube layer 132 is between the protective module 10 and the light guide plate 152.

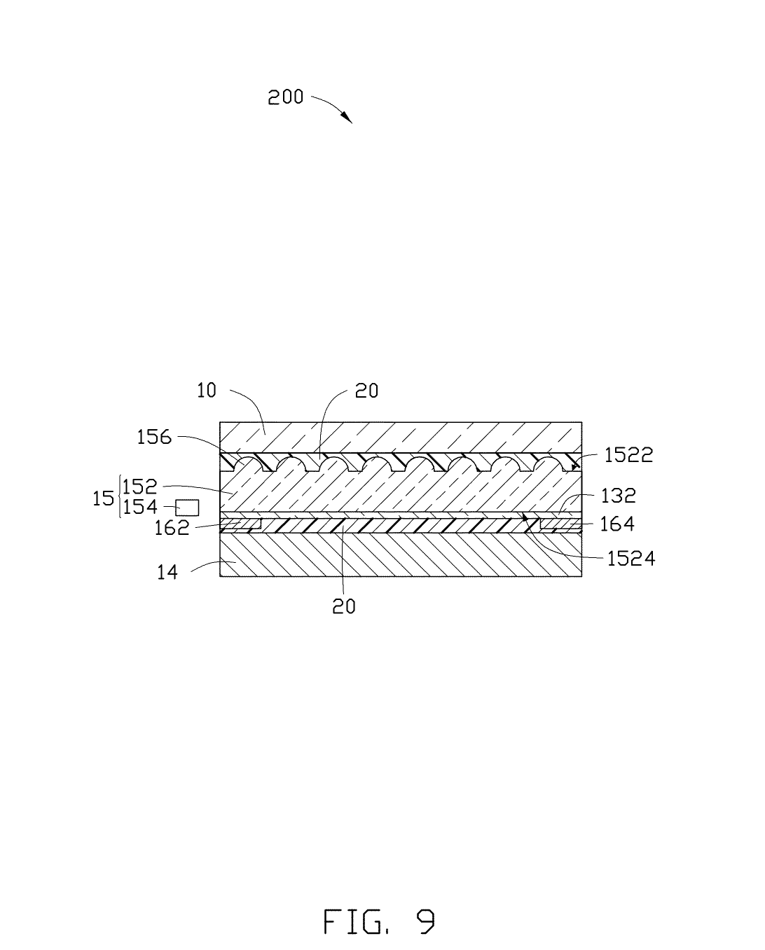

Referring to FIG. 9, a touch-sensitive display device 200 of another embodiment is shown where the at least one carbon nanotube layer 132 is located on the second surface 1524 of the light guide plate 152, and a plurality of scattering dots 156 formed as protrusions on the first surface 1522 of the light guide plate 152.

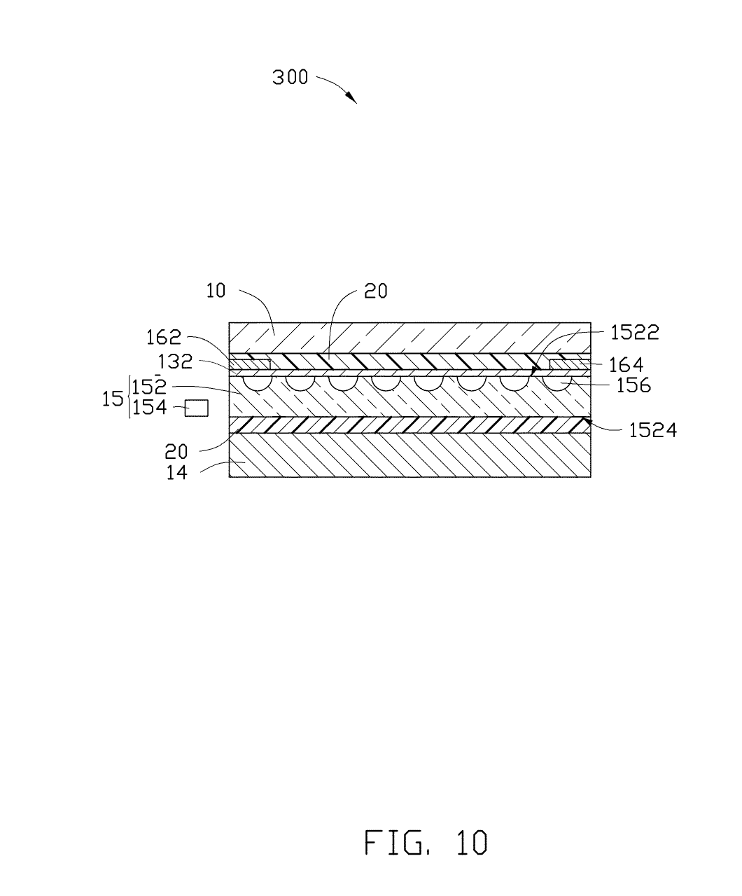

Referring to FIG. 10, a touch-sensitive display device 300 of yet another embodiment is shown where the at least one carbon nanotube layer 132 is located on the first surface 1522 of the light guide plate 152, and a plurality of scattering dots 156 is formed as recessed in the light guide plate 152 at the first surface 1522.

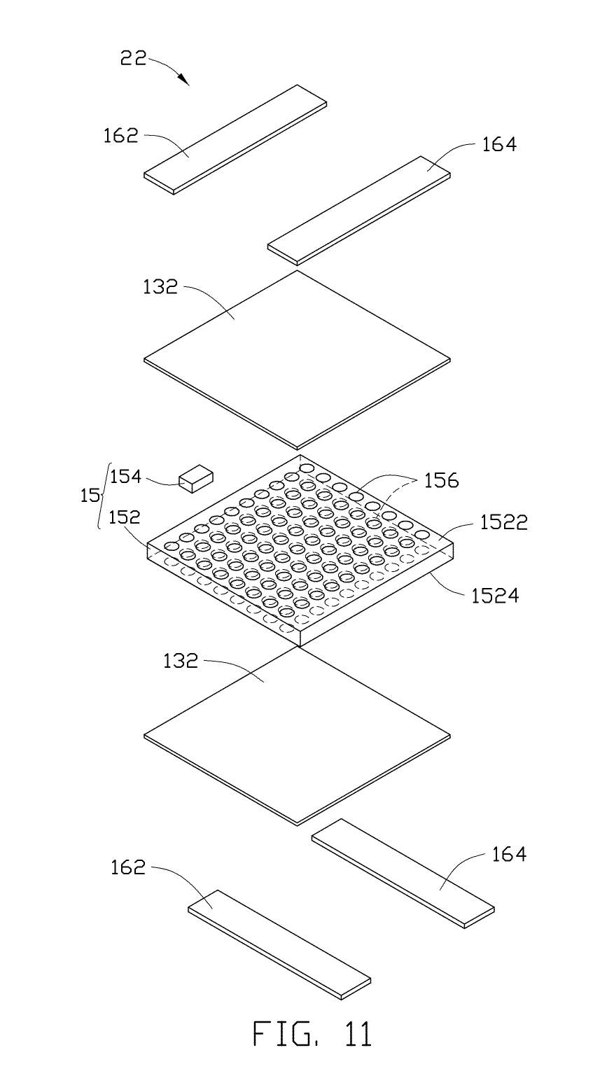

Referring to FIG. 11, a light guide touch module 22 of yet another embodiment is shown where a plurality of scattering dots 156 is formed as recessed in the light guide plate 152 at the first surface 1522 and the second surface 1524, the first surface 1522 and the second surface 1524 are covered by a carbon nanotube layer 132.

The carbon nanotube layer 132 includes a plurality of carbon nanotubes extending along a direction. Extending direction of the plurality of carbon nanotubes in the carbon nanotube layer 132 located on the first surface 1522 is perpendicular to extending direction of the plurality of carbon nanotubes in the carbon nanotube layer 132 located on the second surface 1524. A direction from one of the plurality of first electrodes 162 to the corresponded one of the plurality of second electrodes 164 on the carbon nanotube layer 132 located on the first surface 1522 is perpendicular to a direction from one of the plurality of first electrodes 162 to the corresponded one of the plurality of second electrodes 164 on the carbon nanotube layer 132 located on the second surface 1524.

It is to be understood, when the plurality of scattering dots 156 is formed in the light guide plate 152 at the first surface 1522 and the second surface 1524, the touch module 13 can be only located on the first surface 1522 or only located on the second surface 1524 of the light guide plate 152.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A touch-sensitive display device, comprising:
a protective module;
a reflective display module; and
a light guide touch module located between the protective module and the reflective display module;
wherein the light guide touch module comprises a light guide module and a touch module attached on the light guide module, the light guide module comprises a light guide plate, the touch module comprises at least one carbon nanotube layer directly located on and being in contact with a surface of the light guide plate.

2. The touch-sensitive display device of claim 1, wherein the touch module further comprises at least one first electrode and at least one second electrode, the at least one first and second electrodes are spaced from each other and electrically connected to the at least one carbon nanotube layer.

3. The touch-sensitive display device of claim 1, wherein the light guide plate comprises a first surface and a second surface opposite to the first surface, the first surface is close to the protective module and the second surface is close to the reflective display module, the at least one carbon nanotube layer is located on the first surface of the light guide plate, and a plurality of scattering dots is formed as protrusions on the second surface of the light guide plate.

4. The touch-sensitive display device of claim 1, wherein the light guide plate comprises a first surface and a second surface opposite to the first surface, the first surface is close to the protective module and the second surface is close to the reflective display module, the at least one carbon nanotube layer is located on the first surface of the light guide plate, and a plurality of scattering dots is formed as recessed in the light guide plate at the first surface.

5. The touch-sensitive display device of claim 1, wherein the at least one carbon nanotube layer is a free-standing structure and comprises a plurality of carbon nanotubes.

6. The touch-sensitive display device of claim 5, wherein the at least one carbon nanotube layer is pasted on the light guide plate by van der Waals attractive force.

7. The touch-sensitive display device of claim 5, wherein the at least one carbon nanotube layer is located on the light guide plate by an adhesive layer.

8. The touch-sensitive display device of claim 5, wherein the plurality of carbon nanotubes is joined end-to-end by van der Waals attractive force and extends along a direction.

9. The touch-sensitive display device of claim 8, wherein the touch module comprises a plurality of first electrodes and a plurality of second electrodes, each of the plurality of first electrode and each of the plurality of second electrode is one-to-one correspondence, the plurality of carbon nanotubes extends along a direction from one of the plurality of first electrode to the corresponded one of the plurality of second electrode.

10. The touch-sensitive display device of claim 5, wherein the at least one carbon nanotube layer comprises a plurality of carbon nanotube wire structures arranged in parallel and spaced from each other.

11. The touch-sensitive display device of claim 2, wherein a plurality of scattering dots is formed as recessed in the light guide plate at the first surface and the second surface.

12. The touch-sensitive display device of claim 11, wherein the first surface and the second surface of the light guide plate are covered by a carbon nanotube layer comprising a plurality of carbon nanotubes extending along a direction.

13. The touch-sensitive display device of claim 11, wherein an extending direction of the plurality of carbon nanotubes in the carbon nanotube layer located on the first surface is perpendicular to an extending direction of the plurality of carbon nanotubes in the carbon nanotube layer located on the second surface.

14. The touch-sensitive display device of claim 12, wherein a plurality of first electrodes and a plurality of second electrodes are located on the carbon nanotube layer, a direction from one of the plurality of first electrode to the corresponded one of the plurality of second electrode on the carbon nanotube layer located on the first surface is perpendicular to a direction from one of the plurality of first electrode to the corresponded one of the plurality of second electrode on the carbon nanotube layer located on the second surface.

15. The touch-sensitive display device of claim 1, wherein the light guide module further comprises a light source separated from a side of the light guide plate.

16. A touch-sensitive display device, comprising:
a protective module;
a reflective display module; and
a light guide touch module located between the protective module and the reflective display module;
wherein the light guide touch module comprises a light guide module and a touch module attached on the light guide module, the light guide module comprises a light guide plate having a first surface and a second surface opposite to the first surface, the first surface and the second surface of the light guide plate are covered by a carbon nanotube layer comprising a plurality of carbon nanotubes extending along a direction.

17. The touch-sensitive display device of claim 16, wherein a plurality of scattering dots is formed as recessed in the light guide plate at the first surface and the second surface.

18. The touch-sensitive display device of claim 16, wherein an extending direction of the plurality of carbon nanotubes in the carbon nanotube layer located on the first surface is perpendicular to an extending direction of the plurality of carbon nanotubes in the carbon nanotube layer located on the second surface.

19. The touch-sensitive display device of claim 16, wherein a plurality of first electrodes and a plurality of second electrodes are located on the carbon nanotube layer, a direction from one of the plurality of first electrode to the corresponded one of the plurality of second electrode on the carbon nanotube layer located on the first surface is perpendicular to a direction from one of the plurality of first electrode to the corresponded one of the plurality of second electrode on the carbon nanotube layer located on the second surface.

20. A touch-sensitive display device, comprising:
a protective module;
a reflective display module; and
a light guide touch module located between the protective module and the reflective display module;
wherein the light guide touch module comprises a light guide module and a touch module attached on the light guide module, the light guide module comprises a light guide plate having a first surface and a second surface opposite to the first surface, the touch module comprises at least one carbon nanotube layer directly located on the first surface, and a plurality of scattering dots is formed as protrusions on the second surface of the light guide plate.
